(19) United States
(12) Patent Application Publication
(10) Pub. No.: US 2004/0084499 A1
(43) Pub. Date: May 6, 2004

(54) Pneumatic nailing machine

(76) Inventor: Chien-Fang Tsai, Tainan (TW)

Correspondence Address: Chien-Fang Tsai, P.O. Box No.6-57, Chung-Ho, Taipei, 235, TW

(21) Appl. No.: 10/286,838

(22) Filed: Nov. 4, 2002

(51) Int. Cl. B25C 5/02

(52) U.S. Cl. 227/109; 227/123

(57) ABSTRACT

A pneumatic nailing machine mainly includes a main body, a guide nail block, a clamping block and a nail magazine; a clamping block is pivotally disposed on a lateral side of the guide nail block; the bottom end of the clamping block forms a push portion and the top end thereof forms a clamping portion. Pushing a magazine cover of the nail magazine upwardly to the top end of a guide nail plate pushes the push portion of the clamping block thereby making the clamping portion clamp a guide plate cover onto the guide nail block. Before detaching the magazine cover, the guide plate cover always clamps to the guide nail block so as to prevent the guide plate cover from opening mistakenly to accidentally eject nails.

### BACKGROUND OF THE INVENTION

1) Field of the Invention

The present invention relates to a pneumatic nailing machine, more particularly to a nailing machine having a clamping block pivotally disposed on a lateral side of a guide nail plate for clamping a guide plate cover thereby preventing it from opening accidentally and ejecting nails to injure people; in addition, the guide plate cover is respectively and concavely disposed with nailing channels of different depths for shooting nails of different thickness.

2) Description of the Prior Art

Accordingly, interior decoration, wooden furniture making or assembly usually requires the application of a pneumatic nailing machine. Roughly, nails used for the pneumatic nailing machine are divided as an U-shaped nail and a T-shaped nail for assembling different objects. In addition, nails come in different lengths and thickness. Actually, conducting a nailing job usually requires the use of nails of various shapes, lengths and thickness. However, most of the available pneumatic nailing machine is capable of using nails of the same shape and length. Therefore the application of a conventional pneumatic nailing machine is very limited. Most of the conventional pneumatic nailing machines, as indicated in “Improved Nailing Machine” of Taiwan Patent No, 351236, have a nail magazine longitudinally disposed on a main body; a plurality of positioning slots form on the nail magazine with interval distances allowing nails of different lengths to go through. The positioning slot at the most front aspect forms a nail receiving slot longitudinally for placing in the nails; two lateral sides at the front aspect of the nail magazines respectively form a guide channel. A guide nail plate screws onto the nail magazine and a guide plate cover screws onto the guide nail plate for preventing the nails from ejecting out the nail receiving slot. When the nail is jammed or the machine breaks down, it is necessary to first unscrew the guide nail plate for removing the jammed nail. However, there are more nails left in the nail magazine usually. Therefore, once the guide nail plate opens, the nail jammed or left therein immediately ejects outwardly thereby very possibly injuring a user. It is very dangerous. In order to solve this problem, some industrials developed a clamp-type nail magazine. It only requires removing the nail magazine before opening the guide nail plate for preventing the ejection of the nail and the injury. However, some users tend to forget removing the nail magazine first and instead, mistakenly open the guide nail plate first thereby getting injured. Therefore, the application thereof is still not preferred and fails to be practical.

In viewing the abovementioned shortcomings of the conventional pneumatic nailing machine, the inventor developed the present invention through researching, experimenting and improving the prior art to solve said shortcomings and troublesomeness.

### SUMMARY OF THE INVENTION

The primary objective of the present invention is to provide a pneumatic nailing machine capable of preventing a guide plate cover from opening mistakenly and ejecting nails to injury people, using nails of different shapes, lengths and thickness, having preferred fastening for a magazine cover of a nail magazine and bearing even force on a moving push nail block.

To enable a further understanding of achieving the above-mentioned objectives and effectiveness, the technical contents of the present invention is described by the brief description of the drawings and the detailed description of a preferred embodiment.

### BRIEF DESCRIPTION OF THE DRAWINGS

FIG. 1 is a pictorial and exploded drawing of the present invention.

FIG. 2 is a pictorial drawing of assembling the present invention.

FIG. 3 is a schematic drawing of the structure of a magazine cover of the present invention.

FIG. 4 is a cross-sectional drawing of the assembly of the present invention.

FIG. 5 is a schematic drawing of a not clamped clamping block of the present invention.

FIG. 6 is a schematic drawing of a clamped clamping block of the present invention.

FIG. 7 is a schematic drawing of the present invention using an U-shaped nail.

FIG. 8 is a partial cross-sectional drawing of the present invention using an U-shaped nail as illustrated in A-A of FIG. 7.

FIG. 9 is a schematic drawing of the present invention using a T-shaped nail.

FIG. 10 is a partial cross-sectional drawing of the present invention using a T-shaped nail as illustrated in B-B of FIG. 9.

### DETAILED DESCRIPTION OF THE PREFERRED EMBODIMENTS

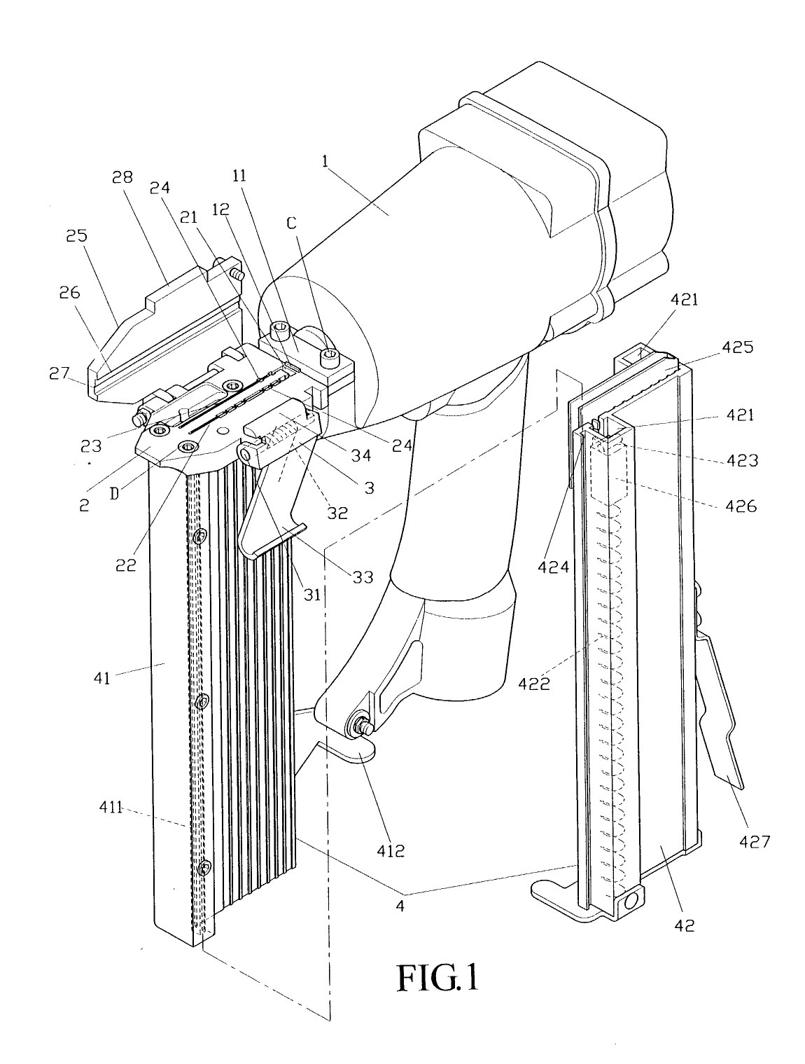

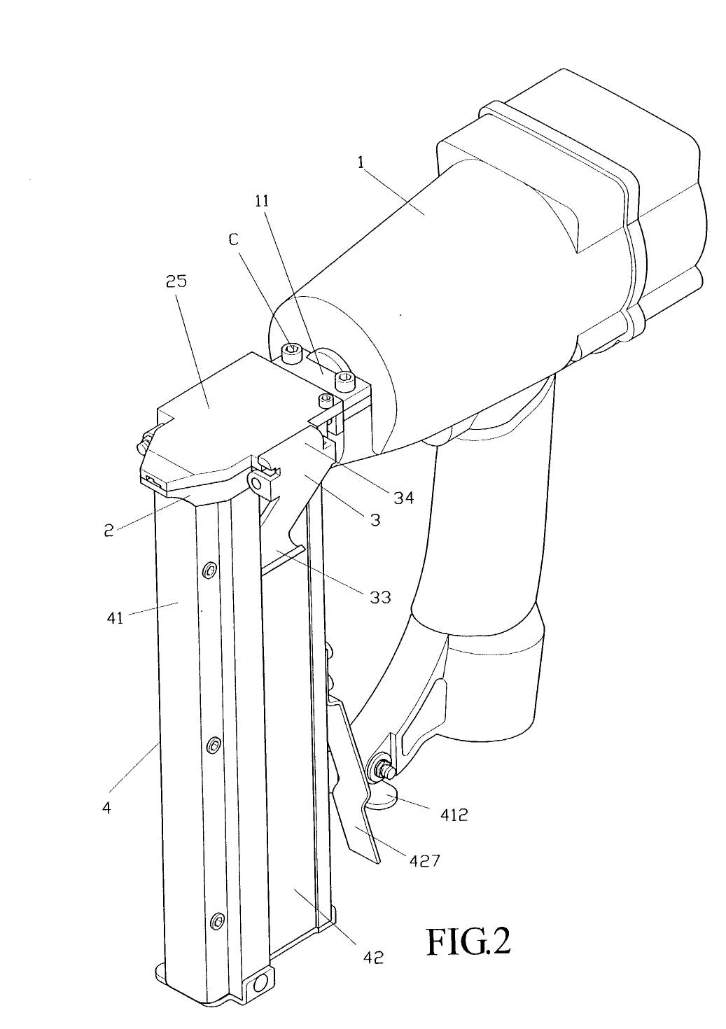

Referring to FIGS. 1 and 2, the present invention mainly comprises a main body (1), a guide nail block (2), a clamping block (3) and a nail magazine (4); wherein the main body (1) is disposed with a joint portion (11) at the front end thereof; a percussion piece (12) is disposed on the joint portion (11).

The guide nail block (2) is fixed at a front end area of the joint portion (11) of the main body (1) and disposed with an U-shaped guide nail slot (21); two lateral sides of the U-shaped guide nail slot (21) are respectively disposed with two nail outlets (22, 23); a plurality of positioning holes (24) are disposed respectively on two nail outlets (22, 23); one lateral side of the guide nail block (2) pivotally connects with a guide plate cover (25); the position area on the guide plate cover (25) opposite the two nail outlets (22, 23) is respectively and concavely disposed with nailing channels (26, 27) of different depths; wherein the depth of the nail channel (26) is smaller than that of the nail channel (27); a clamping piece (28) is disposed convexly on one lateral side of the guide plate cover (25).

The clamping block (3) is pivotally disposed on the other lateral side of the guide nail block (2). A torsion spring (32) penetrates a pivot shaft (31) of the clamping block (3); the bottom end of the clamping block (3) forms a push portion (33), the top end thereof forms a clamping portion (34).

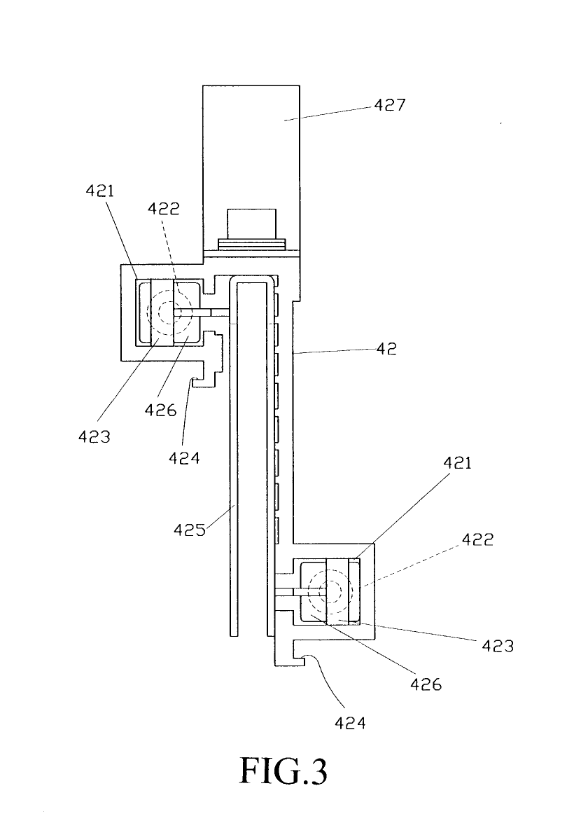

The nail magazine (4) screws at the lower aspect of the guide nail block (2) and comprises a guide nail plate (41) and a magazine cover (42); wherein the guide nail plate (41) vertically screws at the lower aspect area of the guide nail block (2); the front and rear lateral sides of the guide nail plate (41) are respectively disposed with a sliding passage (411); a retaining piece (412) is disposed in the lower aspect area of the guide nail plate (41) to connect with the main body (1). The magazine cover (42) clamps onto the guide nail plate (41), as indicated in FIG. 3. The front and rear lateral sides of the magazine cover (42) are respectively disposed with a receiving slot (421); the two receiving slots (421) are respectively disposed with a spring (422). The top end area of the receiving slot (421) is disposed with a stop block (423) for preventing the spring (422) from dropping off the receiving slot (421). Furthermore, lateral side areas of the two receiving slots (421) are respectively and convexly disposed with a sliding rail (424) and a C-shaped push nail block (425). Two lateral sides of the push nail blocks (425) are disposed respectively with a sliding block (426) in the receiving slots (421) to press the spring (422), to be blocked by the stop block (423) and to slide up-and-down in the receiving slot (421) for pushing a nail upwardly. A resilient tab (427) is convexly disposed on the outer rim of the magazine cover (42).

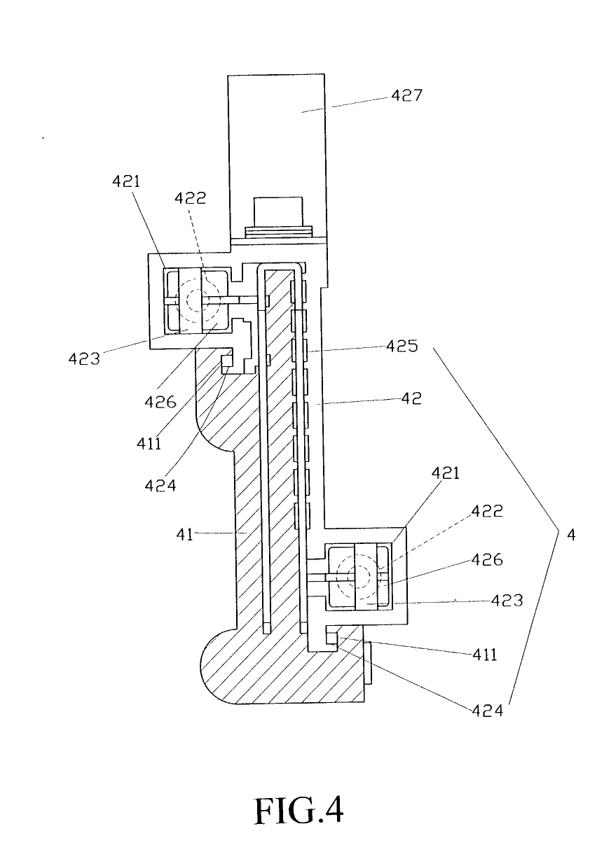

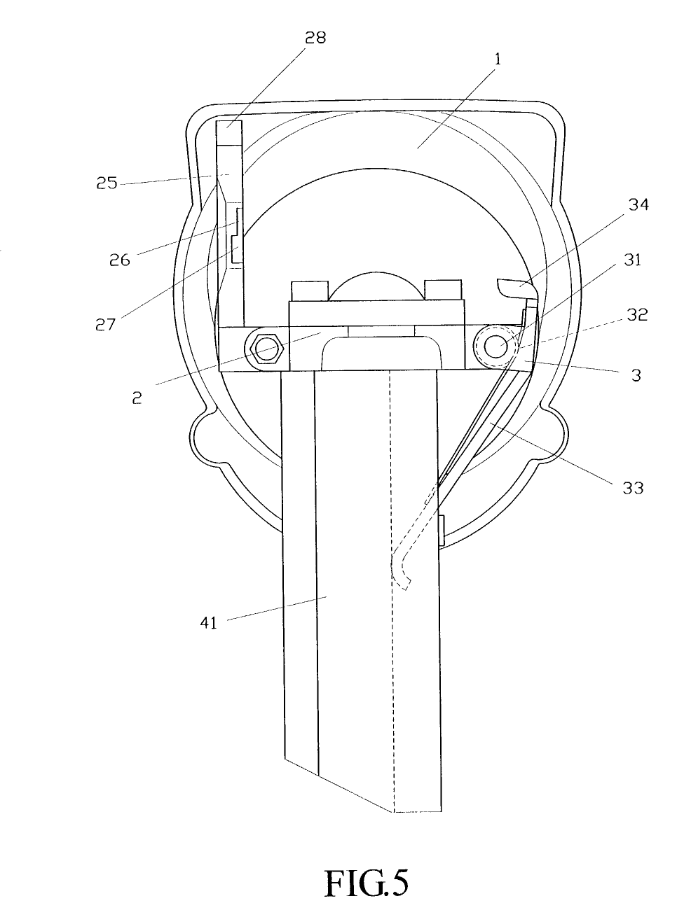

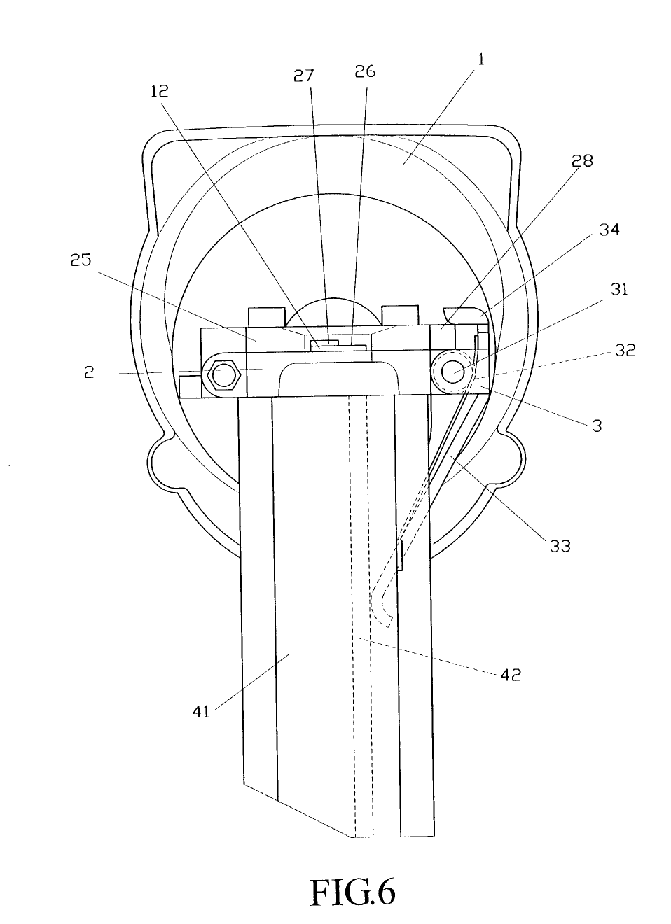

When assembling, as indicated in FIG. 4, the guide nail block (2) is first fixed in the front end area of the joint portion (11) of the main body (1) by a plurality of screwing elements (C); then a torsion spring (32) penetrates onto the pivot shaft (31) of the clamping block (3) thereby pivotally connecting onto the other lateral side of the guide nail block (2). After that, the guide nail plate (41) vertically screws in the lower aspect area of the guide nail block (2) via a plurality of screwing elements (D); through the resilient function of the torsion sprint (32), the push portion (33) of the clamping block (3) tightly abuts and forces the outer rim of the guide nail plate (41). Two sliding rails (424) of the magazine cover (42) are disposed inside the sliding passages (411) of the guide nail plate (41); the push nail block (425) covers the outer rim of the guide nail plate (41). The magazine cover (42) pushes upwardly till the push nail block (425) leans against the lower aspect area of the guide nail block (2) and penetrates the two nail outlets (22, 23). When the magazine cover (42) moves upwardly to the top end of the guide nail plate (41), as indicated in FIG. 5, the top end of the magazine cover (42) pushes the push portion (33) at the bottom end of the clamping block (3) to open outwardly and press the torsion spring (32). Therefore, the clamping block (3) forms a lever function to clamp the clamping portion (34) at the top end of the clamping block (3) onto the clamping piece (28) of the guide plate cover (25), as indicated in FIG. 6. the pressing force of the torsion spring (32) makes the guide plate cover (25) steadily cover the upper aspect area of the guide nail block (2) to prevent it from being opened. When magazine cover (42) pushes to position, the resilient tab (427) at the lower aspect of the magazine cover (42) inserts onto the retaining piece (412) in the lower aspect area of the guide nail plate (41) thereby fastening the magazine cover (42) and preventing it from getting loose. At the same time, the push portion (33) of the clamping block (3) presses the magazine cover (42) and that eliminates the gap generated by the clamped magazine cover (42) and the guide nail plate (41) so as to make the assembly more stable.

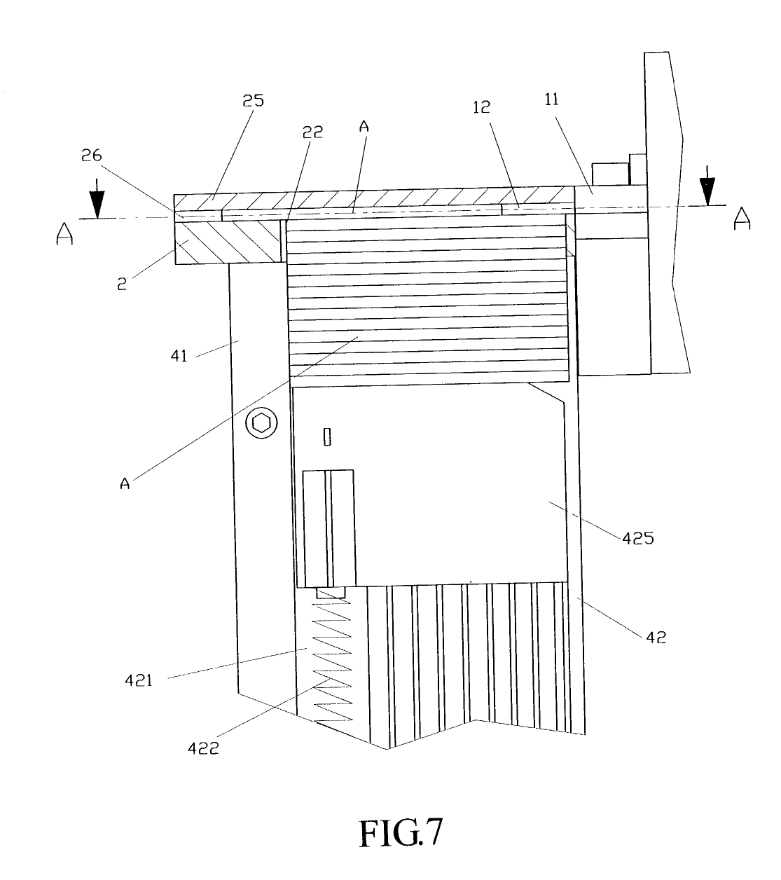

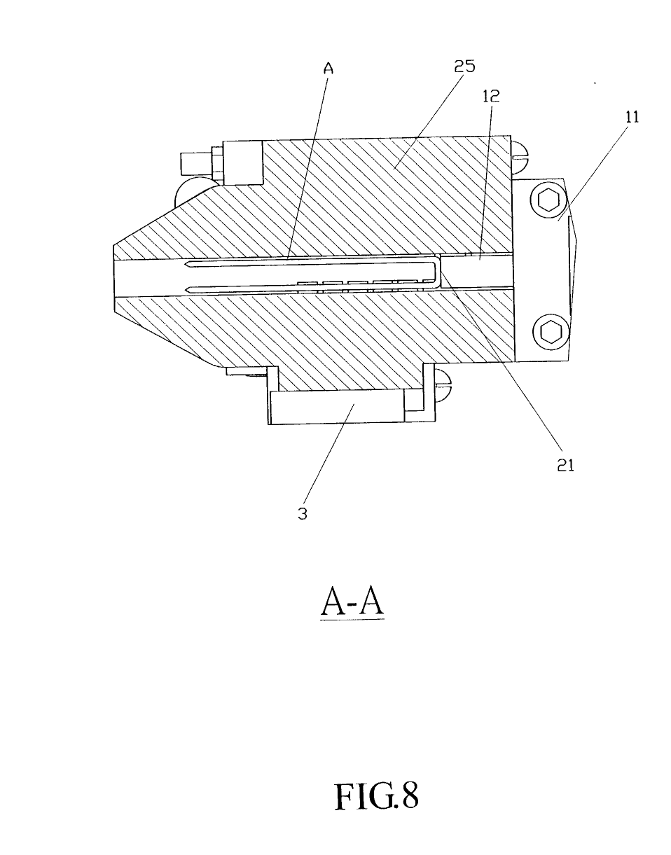

When using U-shaped nails (A), as indicated in FIGS. 7 and 8, the entire stack of U-shaped nails (A) is placed in the upper aspect area of the push nail block (425). Two springs (422) press the push nail block (425) upwardly to make the U-shaped nails (A) ascend along the guide nail plate (41), pass the two nail outlets (22, 23) and enter the nailing channels (26, 27). When shooting the nail, the percussion piece (12) on the joint portion (11) shoots the U-shaped nails (A) outwardly from two nailing channels (26, 27) to nail into the work object. Pushed by the resilient force of two springs (32), the two sliding blocks (426) disposed on two lateral sides of the push nail block (425) drive the push nail block (425) to move upwardly; the two lateral sides of the push nail block (425) bear even force and very steadily move the U-shaped nails (A) upwardly thereby eliminating slanting movement due to uneven force bearing and the situation of jammed nails.

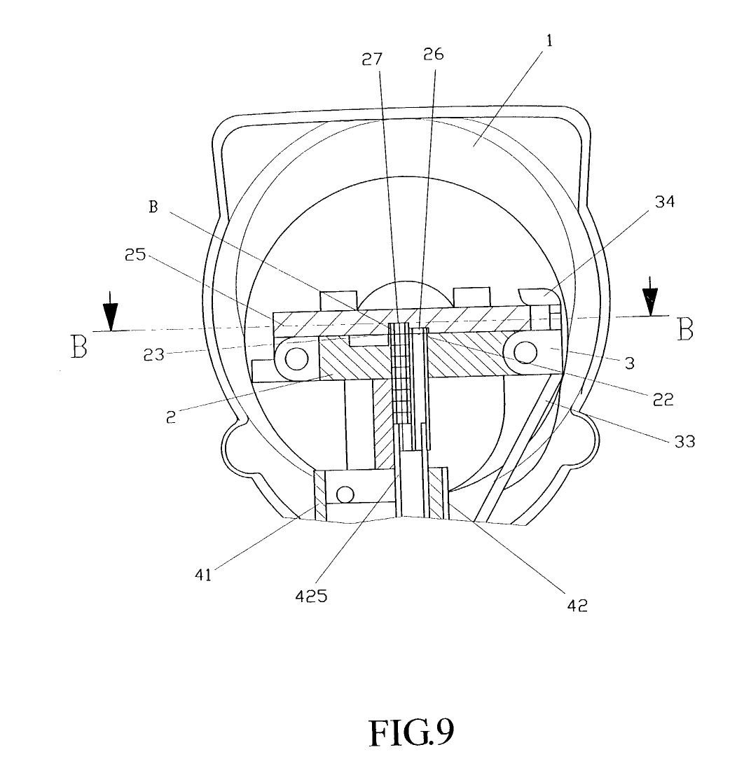

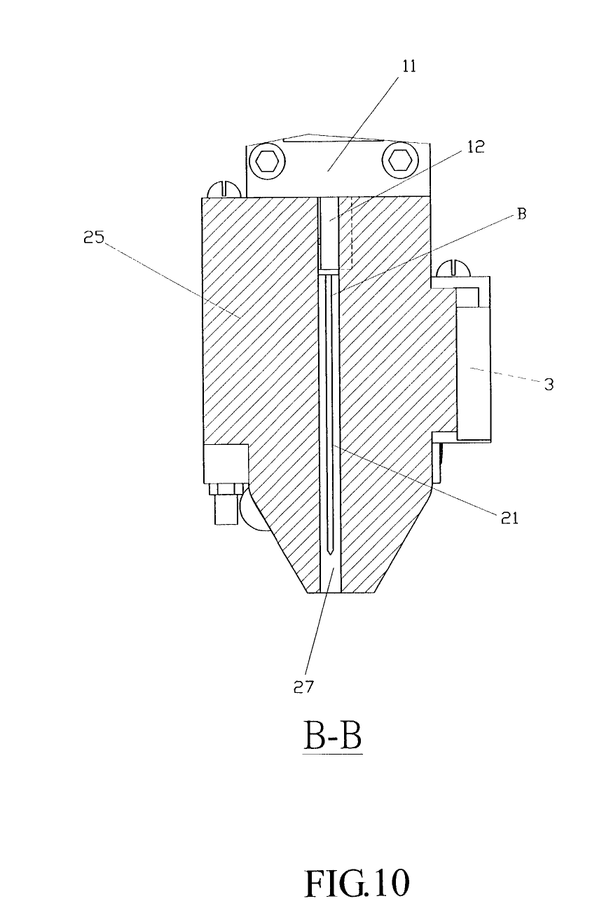

When using T-shaped nails (B), as indicated in FIGS. 9 and 10, one of the nailing channels (26, 27) of different depths is selected to fit the thickness of the T-shaped nails (B). For thicker T-shaped nails (B), the nail channel (27) with deeper depth is selected. The T-shaped nails (B) are placed in the lower aspect area opposite the nail outlet (23) of the nailing channel (27) position; that is one lateral side area opposite the guide nail plate (41). As the same, the push nail block (425) moves the T-shaped nails (B) upwardly to pass the nail outlet (23) of the guide nail slot (21) and enter the nailing channel (27). However, since the length of the T-shaped nails (B) are not the same, the nail heads thereof pass through different positioning holes (24) for shooting. For thinner T-shaped nails (B), the nailing channel (26) with shallow depth is selected. The T-shaped nails (B) are placed in the lower aspect area opposite the nail outlet (23) of the nailing channel (27) position; that is the other lateral side area opposite the guide nail plate (41). Therefore, the T-shaped nails (B) are provided for smooth shooting.

When the nails (A or B) are jammed or the machine breaks down, it is necessary to first press the resilient tab (427) of the magazine cover (42) to make it not insert onto the retaining piece (412) of the guide nail plate (41) for easily removing the magazine cover (42). When moving downwardly, top end of the magazine cover (42) no longer pushes the push portion (33) of the clamping block (3) such that the push portion (33) of the clamping block (3) resumes via the resilient force of the torsion spring (32). Therefore, the clamping block (3) forms a lever function to make the clamping portion (34) at the top end of the clamping block (3) no longer clamp onto the clamping piece (28) of the guide plate cover (25). Therefore, the guide plate cover (25) opens easily for removing any jammed nails (A or B). However, before the guide plate cover (25) is opened, the magazine cover (42) is already removed; therefore, the nails (A or B) left inside will not eject outwardly thereby preventing the user from getting injured and assuring the safety at work.

In summation, the present invention specifically has the following advantages:

1. When opening the guide plate cover, it is necessary to remove the magazine cover to make the clamping block no longer clamp to the guide plate cover for easily opening the guide plate cover thereby preventing the accident of injuring people by the ejected nails due to mistakenly opening the guide plate cover before removing the magazine cover.

2. The present invention is not only suitable for using nails of various shapes and lengths, but also, for the first time, suitable for installing nails with different thickness without using another nailing machine in different dimensions thereby achieving the objective of saving time and labor.

3. The push portion of the clamping block presses and clamps the outer rim area of the magazine cover thereby eliminating the gap generated between the clamped magazine cover and the guide nail plate; therefore, the magazine cover has preferred fixedness and connects with the guide nail plate more steadily.

4. Bearing even resilient force from the spring, the two sliding blocks disposed on two lateral sides of the push nail block pushes the push nail portion to more upwardly thereby eliminating the slant movement due to uneven force bearing and jammed nail situation.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A pneumatic nailing machine comprises at least a main body, a guide nail block, a clamping block and a nail magazine; wherein the guide nail cover is fixedly connects onto the main body; a guide nail slot is disposed on the guide nail block; one lateral side of the guide nail block pivotally connects with a guide plate cover; the lower aspect area of the guide nail block is disposed with a guide nail plate having a nail magazine; a magazine cover clamps onto the guide nail plate; a push nail block capable of moving up-and-down is disposed on the magazine cover;
the present invention is characterized that a clamping block is pivotally disposed on one lateral side of the guide nail block; the bottom end of the clamping block forms a push portion; the top end thereof forms a clamping portion; when the magazine cover moves upwardly to reach the top end of the guide nail plate, it pushes the push portion of the clamping block thereby making the push portion clamp the guide plate cover onto the guide nail block; when the magazine cover is not removed, the guide plate cover always clamps onto the guide nail block.

2. A pneumatic nailing machine comprises a guide nail block fixedly connects onto a main body; a guide nail slot is disposed onto a guide nail block and has two nail outlets; a guide plate cover is jointly disposed on the guide nail block; the lower aspect area of the guide nail block is jointly disposed with a guide nail plate having a nail magazine; a magazine cover clamps onto the guide nail plate; a push nail block capable of moving up-and-down is disposed on the magazine cover;
the present invention is characterized that nailing channels of different depths are respectively and concavely disposed in the position area where the guide plate cover opposites the two nail outlets of the guide nail slot; wherein the depth of one nail outlet is smaller than that of the other nailing channel for shooting nails of different thickness.
